(19) United States
(12) Patent Application Publication
(10) Pub. No.: US 2009/0262389 A1
(43) Pub. Date: Oct. 22, 2009

(54) IMAGE FORMATION APPARATUS CAPABLE OF RECEIVING POWER FROM A PLURALITY OF POWER SOURCES AND CONTROL METHOD PERFORMED IN SUCH IMAGE FORMATION APPARATUS

(75) Inventor: Takeshi TAMADA, Toyahashi-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/337,404

(22) Filed: Dec. 17, 2008

(30) Foreign Application Priority Data
Apr. 16, 2008 (JP) 2008-106938

(51) Int. Cl. G06F 3/12

(52) U.S. Cl. 358/1.15

(57) ABSTRACT

If commercial power is received (YES at step S100), a CPU determines whether any print instruction has been received (step S102). If not (NO at step S102), the CPU maintains a low power consumption mode (step S104). If there is any print instruction received (YES at step S102), the CPU returns from the low power consumption mode to a normal mode (step S106), and performs a print process in accordance with the print instruction (step S108).

This application is based on Japanese Patent Application No. 2008-106938 filed with the Japan Patent Office on Apr. 16, 2008, the entire content of which is hereby incorporated by reference.

### BACKGROUND OF THE INVENTION

1. Field of the Invention

The present invention relates generally to image formation apparatuses capable of receiving power from a plurality of power sources and control methods performed in the image formation apparatuses, and particularly to configurations capable of receiving power via a communication line.

2. Description of the Related Art

In recent years there has been proposed a configuration supplying a networked device with power through a communication line transmitting and receiving a communication signal (or a data signal). Such configuration is noted as a method of supplying power for driving Internet Protocol (IP) telephones, wireless access points, network cameras, and the like in particular. As a representative example of a network configuration equipped with a power supplying function as described above is established Institute of Electrical and Electronic Engineers (IEEE) 802.3af. IEEE 802.3af is a standard for supplying predetermined direct-current (DC) power via a communication line used for Ethernet. It is also referred to as Power over Ethernet (PoE). Furthermore, there also exists a power supply system referred to as a universal serial bus (USB) bus power system for a USB standard mainly for connecting a body of a computer and peripheral equipment.

In recent years, as there is an increasing concern about environmental issues, approaches have been made to reduce power consumed by a variety of apparatuses. For example Japanese Laid-Open Patent Publication No. 2005-250739 discloses electronic equipment that can reduce that cumbersomeness of operating both a power supply of a host device and that of the equipment in connecting to the host device via a connection cable without increasing power consumed by the equipment when it is powered off. Furthermore Japanese Laid-Open Patent Publication No. 2003-158529 discloses a power supply control system in a LAN device including a plurality of LAN ports and a plurality of power supply ports supplying power to a shared device configuring a LAN. In this power supply control system when there is not a link formed between the shared device and all clients, power supplied to the shared device connected to the power supply port is stopped.

Furthermore, as one such attempt to reduce power consumption, as described above, there can be discussed a power supply management system for example for an office in which business equipment is supposed to be used only within predetermined business hours. More specifically, after all users have left the office (e.g., at night), the system entirely stops supplying the office with electric power.

If there is in the office a facsimile device or a similar device communicating data with an external device, however, it is necessary to maintain the facsimile or similar device in a status allowing the device to be constantly capable of receiving data. It is thus difficult to entirely stop supplying the office with power supply. Furthermore the above prior art documents only disclose a configuration based on a state in which main power supply is externally supplied, and cannot resolve such a problem as above.

### SUMMARY OF THE INVENTION

The present invention has been made to overcome such disadvantage, and it contemplates an image formation apparatus capable of continuing to communicate data with another apparatus if external power received from an external power source is interrupted, and a control method performed in the image formation apparatus.

The present invention also contemplates an image formation apparatus capable of avoiding unnecessary power consumption when supplying from the external power source the external power that has been interrupted is resumed, and a control method performed in the image formation apparatus.

The present invention in one aspect provides an image formation apparatus connected through a data communication line to a power supplying device capable of supplying power through the data communication line. The image formation apparatus includes: a power load unit for performing a process involved in forming an image; a power conversion unit receiving external power from an external power source and converting the external power to first drive power; a separation unit connected to the data communication line, and separating a communication signal and supplied power flowing through the data communication line, and outputting as second drive power the supplied power separated; a data communication unit for communicating data with an external device; a control unit changing a mode of operation at least between a first mode allowing the process in the power load unit to be performed on the external power and a second mode dispensing with the external power; a power supply unit continuously supplying at least the control unit and the data communication unit with one of the first drive power and the second drive power; and a first detection unit detecting the external power. When supplying the external power is started in the second mode: the control unit changes the mode of operation from the second mode to the first mode if the data communication unit has received a print instruction; and the control unit maintains the second mode if the data communication unit has not received the print instruction.

Preferably, the image formation apparatus further includes a display unit capable of displaying information. When the data communication unit receives the print instruction in the second mode: the control unit changes the mode of operation from the second mode to the first mode if the external power is received; and the control unit causes the display unit to display an indication urging supplying the external power if the external power is not received.

Preferably, the data communication unit includes a first communication unit communicating data by the communication signal and a second communication unit communicating data through a telephone line. The control unit includes a storage unit storing the print instruction received by the first communication unit and the print instruction received by the second communication unit. When supplying the external power is started in the second mode, the control unit maintains the second mode if the storage unit has stored therein only the print instruction received by the first communication unit.

Preferably, while the second mode is set, the control unit prevents a power conversion operation in the power conversion unit.

The present invention in another aspect provides an image formation apparatus connected through a data communication line to a power supplying device capable of supplying power through the data communication line. The image formation apparatus includes: a power load unit for performing a process involved in forming an image; a power conversion unit receiving external power from an external power source and converting the external power to first drive power; a switch unit disposed on a power path extending from the external power source to the power conversion unit for opening and closing the power path; a separation unit connected to the data communication line, and separating a communication signal and supplied power flowing through the data communication line, and outputting as second drive power the supplied power separated; a data communication unit for communicating data with an external device; a control unit changing a mode of operation at least between a first mode allowing the process in the power load unit to be performed on the external power and a second mode dispensing with the external power; a power supply unit continuously supplying at least the control unit and the data communication unit with one of the first drive power and the second drive power; a first detection unit detecting the external power; and a second detection unit detecting a status of the switch unit. When supplying the external power is started in the second mode: the control unit changes the mode of operation from the second mode to the first mode if the switch unit assumes a closed position and the data communication unit has received a print instruction; and the control unit maintains the second mode if the data communication unit has not received the print instruction.

Preferably, the image formation apparatus further includes a display unit capable of displaying information. When supplying the external power is started in the second mode, the control unit causes the display unit to display an indication urging changing the switch unit to the closed position if the switch unit assumes an open position and the data communication unit has received the print instruction.

Furthermore, preferably, the image formation apparatus further includes a display unit capable of displaying information. When the data communication unit receives the print instruction in the second mode: the control unit causes the display unit to display an indication urging supplying the external power and an indication urging changing the switch unit to the closed position if the switch unit assumes an open position and the external power is not received; and the control unit causes the display unit to display the indication urging changing the switch unit to the closed position if the switch unit assumes the open position and the external power is received.

Furthermore, preferably, the image formation apparatus further includes a display unit capable of displaying information. When the data communication unit receives the print instruction in the second mode: the control unit causes the display unit to display an indication urging supplying the external power and an indication urging changing the switch unit to the closed position if the switch unit assumes an open position and the external power is not received; and the control unit closes the switch unit if the switch unit assumes the open position and the external power is received.

Preferably, when the switch unit is changed from an open position to the closed position in the second mode, the control unit changes the mode of operation from the second mode to the first mode.

Preferably, the data communication unit includes a first communication unit communicating data by the communication signal and a second communication unit communicating data through a telephone line. The control unit includes a storage unit storing the print instruction received by the first communication unit and the print instruction received by the second communication unit. When the storage unit has stored therein only the print instruction received by the first communication unit, the control unit maintains the second mode if supplying the external power is started in the second mode.

Preferably, while the second mode is set, the control unit prevents a power conversion operation in the power conversion unit.

The present invention in another aspect provides a method of controlling an image formation apparatus connected through a data communication line to a power supplying device capable of supplying power through the data communication line. The image formation apparatus includes: a control unit; a power load unit for performing a process involved in forming an image; a power conversion unit receiving external power from an external power source and converting the external power to first drive power; a separation unit connected to the data communication line, and separating a communication signal and supplied power flowing through the data communication line, and outputting as second drive power the supplied power separated; a data communication unit for communicating data with an external device; and a power supply unit continuously supplying at least the control unit and the data communication unit with one of the first drive power and the second drive power. The image formation apparatus operates in either one of at least a first mode allowing the process in the power load unit to be performed on the external power and a second mode dispensing with the external power. The method includes the steps of: determining whether supplying the external power is started in the second mode; determining whether the data communication unit has received a print instruction; changing a mode of operation from the second mode to the first mode if supplying the external power is started in the second mode and the data communication unit has received the print instruction; and maintaining the second mode if supplying the external power is started in the second mode and the data communication unit has not received the print instruction.

Preferably, the method further includes the steps of: changing the mode of operation from the second mode to the first mode if the data communication unit has received the print instruction in the second mode and the external power is received; and displaying an indication urging supplying the external power if the data communication unit has received the print instruction in the second mode and the external power is not received.

Preferably, the data communication unit includes a first communication unit communicating data by the communication signal and a second communication unit communicating data through a telephone line. The method further includes the steps of: storing the print instruction received by the first communication unit and/or the print instruction received by the second communication unit; and maintaining the second mode if only the print instruction received by the first communication unit has been stored and supplying the external power is started in the second mode.

Preferably, the method further includes the step of preventing a power conversion operation in the power conversion unit while the second mode is set.

The present invention in still another aspect provides a method of controlling an image formation apparatus connected through a data communication line to a power supplying device capable of supplying power through the data communication line. The image formation apparatus includes: a control unit; a power load unit for performing a process involved in forming an image; a power conversion unit receiving external power from an external power source and converting the external power to first drive power; a switch unit disposed on a power path extending from the external power source to the power conversion unit for opening and closing the power path; a separation unit connected to the data communication line, and separating a communication signal and supplied power flowing through the data communication line, and outputting as second drive power the supplied power separated; a data communication unit for communicating data with an external device; and a power supply unit continuously supplying at least the control unit and the data communication unit with one of the first drive power and the second drive power. The image formation apparatus operates in either one of at least a first mode allowing the process in the power load unit to be performed on the external power and a second mode dispensing with the external power. The method includes the steps of: determining whether supplying the external power is started in the second mode; determining whether the data communication unit has received a print instruction; determining a status of the switch unit; changing a mode of operation from the second mode to the first mode if supplying the external power is started in the second mode, the switch unit assumes a closed position, and the data communication unit has received the print instruction; and maintaining the second mode if supplying the external power is started in the second mode and the data communication unit has not received the print instruction.

Preferably, the method further includes the step of displaying an indication urging changing the switch unit to the closed position if supplying the external power is started in the second mode, the switch unit assumes an open position, and the data communication unit has received the print instruction.

Preferably, the method further includes the steps of: displaying an indication urging supplying the external power and an indication urging changing the switch unit to the closed position if the data communication unit has received the print instruction in the second mode, the switch unit assumes an open position, and the external power is not received; and displaying the indication urging changing the switch unit to the closed position if the data communication unit has received the print instruction in the second mode, the switch unit assumes the open position, and the external power is received.

Preferably, the method further includes the steps of: displaying an indication urging supplying the external power and an indication urging changing the switch unit to the closed position if the data communication unit has received the print instruction in the second mode, the switch unit assumes an open position, and the external power is not received; and closing the switch unit if the data communication unit has received the print instruction in the second mode, the switch unit assumes the open position, and the external power is received.

Preferably, the method further includes the step of changing the mode of operation from the second mode to the first mode if the switch unit is changed from an open position to the closed position in the second mode.

Preferably, the data communication unit includes a first communication unit communicating data by the communication signal and a second communication unit communicating data through a telephone line. The method further includes the steps of: storing the print instruction received by the first communication unit and/or the print instruction received by the second communication unit; and maintaining the second mode if only the print instruction received by the first communication unit is stored and supplying the external power is started in the second mode.

Preferably, the method further includes the step of preventing a power conversion operation in the power conversion unit while the second mode is set.

In accordance with the present invention, if an apparatus is interrupted from receiving external power from an external power source, the apparatus can still continue to communicate data with another apparatus, and unnecessary power consumption can be avoided when supplying from the external power source the external power that has been interrupted is resumed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an appearance of an image formation apparatus according to a first present embodiment.

FIG. 2 is a block diagram showing a configuration in function of the image formation apparatus according to the first embodiment.

FIG. 3 is a schematic block diagram showing a configuration of a main portion involved in supplying power in accordance with the first embodiment.

FIG. 4 is a diagram for illustrating a mode set in the image formation apparatus in accordance with the first embodiment.

FIG. 5 shows an example of an indication displayed in a display unit for a status 3 shown in FIG. 4.

FIG. 6 is a block diagram showing a configuration of a function in a control unit in accordance with the first embodiment.

FIG. 7 is a flowchart of a procedure of a process in the image formation apparatus in accordance with the first embodiment.

FIG. 8 is a schematic diagram showing an exemplary application of the image formation apparatus in accordance with the first embodiment.

FIG. 9 is a schematic block diagram showing a configuration of a main portion involved in supplying power in accordance with a second embodiment.

FIG. 10 is a diagram for illustrating a mode set in the image formation apparatus in accordance with the second embodiment.

FIG. 11 shows an example of an indication displayed in a display unit for a status 3 shown in FIG. 10.

FIG. 12 shows an example of an indication displayed in the display unit for a status 5 shown in FIG. 10.

FIG. 13 is a flowchart of a procedure of a process in the image formation apparatus in accordance with the second embodiment.

FIG. 14 is a schematic block diagram showing a configuration of a main portion involved in supplying power in accordance with the second embodiment in a first exemplary variation.

FIG. 15 is a schematic block diagram showing a configuration of a main portion relevant to a switch unit in accordance with the second embodiment in a second exemplary variation.

### DESCRIPTION OF THE PREFERRED EMBODIMENTS

The present invention in embodiments will now be described with reference to the drawings. In the figures, identical or like components are identically denoted and will not be described repeatedly.

### First Embodiment

Configuration of Apparatus

The present invention is directed to an image formation apparatus connected to a network capable of communicating data and supplying power via a single communication line. In the present embodiment a multi function peripheral (MFP) equipped with a plurality of functions such as a copy function, a print function, a facsimile function and a scanner function will be described as a representative example of the present image formation apparatus. Furthermore a configuration adopting the PoE system established as IEEE 802.3af will be described as a representative example of the network capable of communicating data and supplying power via a single communication line.

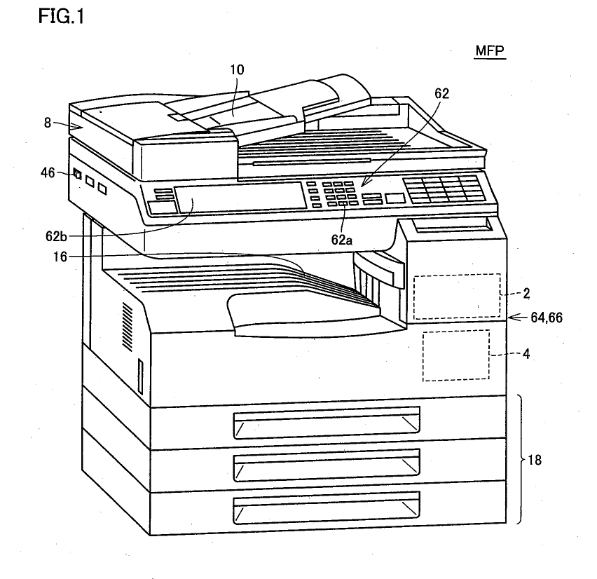

With reference to FIG. 1, the present embodiment provides an image formation apparatus MFP including a control unit 2, a power conditioning unit 4, an image reading unit 8, an automatic document feeding unit 10, a sheet feeding unit 18, a manipulation unit 62, a sensor unit 64, and a drive unit 66. Note that sensor unit 64 and drive unit 66 configure a print engine load unit 6 operating, driving and the like a print engine (not shown) for performing a process involved in forming an image. (Hereinafter this process will also generally be referred to as a “print process”.) They correspond to a power load unit.

Automatic document feeding unit 10 is a unit for reading an original document successively. It is configured of a document feeding tray, a feeding roller, a registration roller, a transport drum, a document receiving tray (all not shown) and the like. When a user manipulates manipulation unit 62 to enter a start instruction, automatic document feeding unit 10 feeds documents placed on the document feeding tray to be read, one by one as the feeding roller operates.

Image reading unit 8 emits light from a source of light toward a passing document to expose it to light and receives a reflection of the light from the document by a pickup device or the like to read image information of the document. Note that image reading unit 8 can also read image information from a document placed on a platen glass. The image information read by image reading unit 8 is transmitted to an image processing unit to undergo a predetermined image process and is thus converted to image data and thereafter transmitted to the print engine.

The print engine forms an image from the image data on a sheet. More specifically, the print engine includes a photoreceptor drum, a charger, an image writing unit (or an exposure unit), a development unit, a transcription unit, a discharger, a fuser and fixer device, a cleaning unit and the like (all not shown). These mechanisms operate in a series to implement the print process. Furthermore sensor unit 64 includes a plurality of sensors for detecting a status of each mechanism in manipulation unit 62, a sensor for detecting how a sheet is transported, a sensor for detecting the temperature of a surface of a heating roller in the fuser and fixer device, and the like. Drive unit 66 includes a motor for rotating the photoreceptor drum and a variety of types of rollers and the like, a laser drive unit driving the exposure unit, and the like.

Sheet feeding unit 18 includes at least one sheet feeding cassette. It is synchronized with the print process in the print engine to feed by a roller or the like a sheet set in a predetermined sheet feeding cassette.

Control unit 2 operates in response to a variety of instructions received via an input key 62a in manipulation unit 62 to control the print engine and causes a display unit 62b or the like to display a variety of information. Note that input key 62a includes a start button pressed to indicate that the print process should start, numeral keys used to enter characters, numbers and the like, and the like. Display unit 62b is representatively configured for example of a liquid crystal display (LCD). Furthermore, control unit 2 changes a mode of operation of image formation apparatus MFP in accordance with a status of power supplied from outside the apparatus, as will be described later.

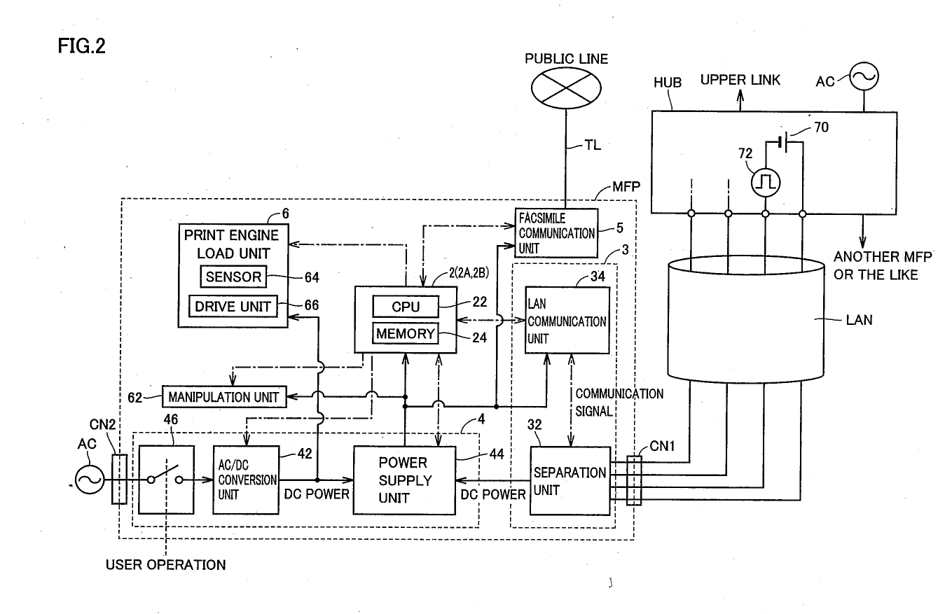

Power conditioning unit 4 is a unit for supplying control unit 2, print engine load unit 6 and the like with power. In particular, the present embodiment provides image formation apparatus MFP that receives power supplied from a plurality of external power sources and thus operates thereon, and hereinafter a configuration receiving alternate-current (AC) power from a power supply system or a like external power source and DC power supplied via a communication line will be illustrated. The former power and the latter power will hereinafter also be referred to as “commercial power” and “network power”, respectively. Note that the image formation apparatus may be adapted to receive power from more types of external power sources other than the two types of power exemplified in the present embodiment. Power conditioning unit 4 supplies one of the commercial power and the network power to at least control unit 2 and a LAN communication unit 34 (FIG. 2) continuously.

Furthermore, image formation apparatus MFP is provided at a power path extending to input commercial power to AC/DC conversion unit 42 (FIG. 2) with switch unit 46 for opening and closing the power path. Switch unit 46 is disposed representatively at a side surface of image formation apparatus MFP and opened (or turned off)/closed (or turned on) by a user. In other words, switch unit 46 functions as a so-called main switch.

With reference to FIG. 2, in the present embodiment, image formation apparatus MFP is connected via a connector CN1 to a communication line LAN and also via communication line LAN to a hub device HUB equipped with a power supplying function. Another image formation apparatus MFP, a personal computer and the like are also connected to hub device HUB, and image formation apparatus MFP can communicate data with hub device HUB, another image formation apparatus MFP, the personal computer and the like.

As has been described previously, hub device HUB is equipped with a power supplying function in accordance with the PoE system. As one example, hub device HUB includes a DC voltage supply 70 and an oscillator 72 connected in series to a pair of communication lines LAN. DC voltage supply 70 is a power source for supplying power and applies a predetermined voltage to the pair of communication lines LAN. Note that according to IEEE 802.3af, it supplies DC power having a voltage value of 48 V. Oscillator 72 superposes on the pair of communication lines LAN a pulsing communication signal (or a data signal) used in communicating data. By such configuration, communication line LAN will include DC network power and a pulsing (or AC) communication signal.

To accommodate this, image formation apparatus MFP in the present embodiment further includes an interface unit 3 connected to communication line LAN. More specifically, interface unit 3 includes a separation unit 32 and LAN communication unit 34.

Furthermore, image formation apparatus MFP includes a facsimile communication unit 5 connected to a telephone line TL and capable of receiving facsimile data transmitted on telephone line TL, a public line or the like from the other end of the line. Note that facsimile communication unit 5 is also capable of transmitting image data or the like that is read from an original document by automatic document feeding unit 10 (FIG. 1) or the like as facsimile data on telephone line TL to the other end of the line, as designated.

Furthermore, image formation apparatus MFP receives commercial power from power supply system AC via connector CN2. The received commercial power is provided to power conditioning unit 4. Power conditioning unit 4 includes switch unit 46, AC/DC conversion unit 42 and power supply unit 44. Switch unit 46 is inserted on a power path extending between power supply system AC and AC/DC conversion unit 42, and, as has been described above, selects an open position or a closed position between them in response to the user's operation. AC/DC conversion unit 42 is a power conversion unit converting AC commercial power received from power supply system AC into DC power, and representatively includes a power transistor or a similar switching element. AC/DC conversion unit 42 outputs the generated DC power to power supply unit 44 as first drive power.

Separation unit 32 separates the communication signal and the network power flowing on communication line LAN from each other. Separation unit 32 is configured including a frequency filer representatively, and outputs a DC component of an electrical signal that propagates on communication line LAN as the network power, and an AC component of the electrical signal as the communication signal. The network power separated by separation unit 32 is output as second drive power to power conditioning unit 4 and received by power supply unit 44. Furthermore, LAN communication unit 34 transmits the communication signal and receives the communication signal separated by separation unit 32. More specifically, LAN communication unit 34 generates a communication signal in accordance with data transmitted from control unit 2 and also decodes a communication signal that is received from separation unit 32 into received data and outputs the data to control unit 2. Note that on a pair of communication lines LAN a bidirectional communication signal may be propagated or a monodirectional communication signal may be propagated. If the monodirectional communication signal is propagated, LAN communication unit 34 will have a transmission function and a reception function independently.

Power supply unit 44 selects one of the first drive power and the second drive power received from AC/DC conversion unit 42 and separation unit 32, respectively, and outputs the selected drive power to control unit 2, LAN communication unit 34, facsimile communication unit 5 and manipulation unit 62 continuously. More specifically, as long as power supply unit 44 receives drive power from at least one of AC/DC conversion unit 42 and separation unit 32, power supply unit 44 can maintain control unit 2, LAN communication unit 34, facsimile communication unit 5 and manipulation unit 62 operatively. Representatively, power supply unit 44 selectively outputs one of the first drive power and the second drive power received from AC/DC conversion unit 42 and separation unit 32, respectively, that has a higher value in voltage.

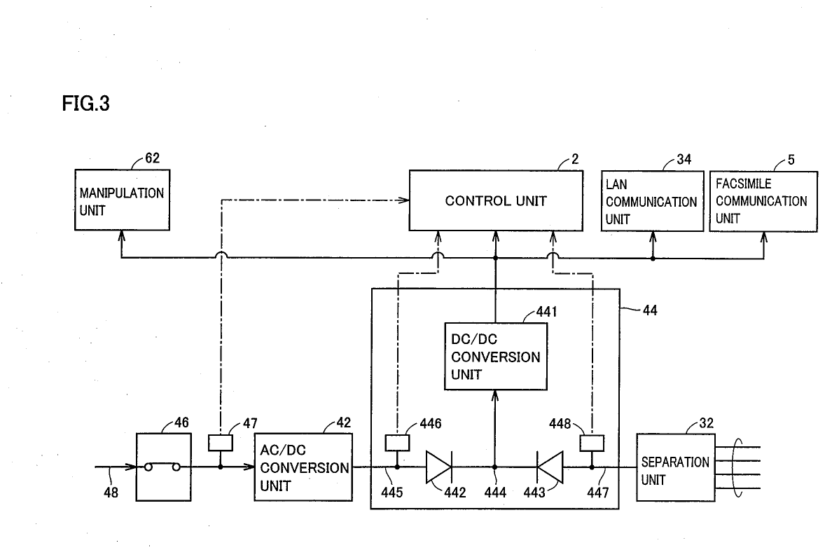

With reference to FIG. 3, in the present embodiment, power supply unit 44 includes a DC/DC conversion unit 441, diodes 442 and 443, and voltage detection units 446 and 448. DC/DC conversion unit 441 is a voltage conversion unit for maintaining at a predetermined voltage the DC drive power supplied from AC/DC conversion unit 42 or separation unit 32. Note that AC/DC conversion unit 42 and separation unit 32 provide drive powers having rated voltage values, respectively, set to be different from each other. In the present embodiment the rated voltage value of the first drive power provided from AC/DC conversion unit 42 is set to be higher than that (for example of 48 V) of the second drive power provided from separation unit 32.

Diodes 442 and 443 are countercurrent prevention devices preventing a countercurrent between AC/DC conversion unit 42 and separation unit 32. More specifically, diode 442 is inserted in a forward direction in an input line 445 extending from AC/DC conversion unit 42 to DC/DC conversion unit 441 and diode 443 is inserted in a forward direction in an input line 447 extending from separation unit 32 to DC/DC conversion unit 441. Such configuration can prevent a current flowing from AC/DC conversion unit 42 toward separation unit 32 or that flowing from separation unit 32 toward AC/DC conversion unit 42.

In addition to such countercurrent prevention function, diodes 442 and 443 fulfill a function for outputting drive power selectively. More specifically, as has been described previously, the rated voltage value of the first drive power is set to be higher than that of the second drive power. Accordingly, when AC/DC conversion unit 42 and separation unit 32 both supply their drive powers, the first drive power having the higher voltage value is selectively output. At the time, a node 444 has a voltage maintained at that of the first drive power. As such, even if the second drive power supplied from separation unit 32 is interrupted, the first drive power output from power supply unit 44 is unaffected. Herein when the first drive power is interrupted, diode 442 transitions from the on state to the off state and diode 443 transitions from the off state to the on state. As a result the second drive power will selectively be output. As the drive powers are thus switched, node 444 has a voltage decreased to that of the second drive power. However, DC/DC conversion unit 441 operates to maintain the voltage that is supplied to control unit 2 to have a constant value, and control unit 2 and LAN communication unit 34 thus have their respective operations unaffected.

Power supply unit 44 thus selects one of the drive powers received from AC/DC conversion unit 42 and separation unit 32 and outputs the selected drive power to control unit 2, LAN communication unit 34, facsimile communication unit 5 and manipulation unit 62 continuously.

Furthermore, voltage detection units 446 and 448 detect the values of the voltages caused on input lines 445 and 447, respectively, and output their respective detection results to control unit 2.

Furthermore between switch unit 46 and AC/DC conversion unit 42 a voltage detection unit 47 is disposed. When switch unit 46 assumes a closed position voltage detection unit 47 detects a value in voltage on a commercial power supply line 48 and outputs the resultant detection to control unit 2. In other words, voltage detection unit 47 detects whether there is commercial power supplied to image formation apparatus MFP.

With reference again to FIG. 2, control unit 2 includes a central processing unit (CPU) 22 performing an operation process, and a memory 24 configured for example of random access memory (RAM), read only memory (ROM) and the like.

Control unit 2, LAN communication unit 34, facsimile communication unit 5 and manipulation unit 62 receive DC power from power supply unit 44 and operate thereon. In contrast, print engine load unit 6 including sensor unit 64 and drive unit 66 receives the first drive power from AC/DC conversion unit 42 and operates thereon.

Mode of Operation

Hereinafter it is assumed that network power is continuously supplied to image formation apparatus MFP through communication line LAN and that switch unit 46 is held at the closed position.

In the present embodiment, control unit 2 changes a mode of operation of image formation apparatus MFP depending on whether commercial power is received. More specifically, control unit 2 changes the mode of operation between a “normal mode” allowing a print process using commercial power and a “low power consumption mode” dispensing with commercial power. Representatively, when commercial power is interrupted, control unit 2 shifts to the low power consumption mode, and when supplying interrupted commercial power is resumed or data is received from external to the apparatus, control unit 2 responsively performs a control operation, as will be described later.

When commercial power is interrupted and accordingly, only the second drive power is supplied, print engine load unit 6 cannot be operated. Accordingly, control unit 2 operates in a range that can at least maintain data communication with another image formation apparatus MFP or the like and facsimile communication with another image formation apparatus or the like.

In general, print engine load unit 6 consumes relatively large power for performing the print process. Network power has a small ability to supply power (according to IEEE 802.3af, 15.4 W at maximum) in comparison with the power consumed by print engine load unit 6, and the print process cannot be performed with network power alone. In other words, while control unit 2, LAN communication unit 34, facsimile communication unit 5, and manipulation unit 62 can operate on network power (i.e., the second drive power), it is difficult that print engine load unit 6, which is a relatively large power load, operates on network power alone.

More specifically, when a personal computer or the like transmits to image formation apparatus MFP through communication line LAN together with data to be printed an instruction for subjecting the data to the print process, control unit 2 stores them temporarily in memory 24. Similarly, when another image formation apparatus MFP transmits facsimile data to image formation apparatus MFP of interest on telephone line TL, control unit 2 stores the facsimile data temporarily in memory 24. After print engine load unit 6 becomes operable, control unit 2 causes it to perform the print process in accordance with the data stored in memory 24. This operation can prevent data transmitted from another apparatus from disappearing for example at night when commercial power supplied to image formation apparatus MFP is interrupted. Hereinafter, data to be printed and an instruction for performing the print process that are transmitted on communication line LAN, and facsimile data transmitted on telephone line TL will also be generally referred to as a “print instruction”. In other words, in the present specification, a “print instruction” means data in general for performing the print process.

On the other hand, only when sufficient drive power allowing print engine load unit 6 to operate is ensured, control unit 2 shifts image formation apparatus MFP to the normal mode and enables print engine load unit 6 to operate.

Note that if supplying commercial power is resumed in the low power consumption mode, and there is no print instruction received, it is not necessary to operate print engine load unit 6. Accordingly, when supplying commercial power is interrupted and image formation apparatus MFP accordingly shifts to the low power consumption mode and supplying commercial power is thereafter resumed, and if there is no need for the print process, then it is preferable to maintain the low power consumption mode in view of reducing power consumption. Accordingly in the present embodiment when supplying commercial power is resumed in the low power consumption mode, control unit 2 determines whether memory 24 has a print instruction stored therein, and if so, control unit 2 returns image formation apparatus MFP from the low power consumption mode to the normal mode.

Note that the low power consumption mode is a mode allowing image formation apparatus MFP to consume smaller power than when it normally operates. In this mode, power supplied for example to a motor driving the photoreceptor drum, power supplied to a heater lamp of the fuser and fixer device, and the like are interrupted. The low power consumption mode includes a mode setting the image formation apparatus in a standby or sleep status, a power supply cutting status, or a status reducing power consumption.

In the low power consumption mode control unit 2 stops a power conversion operation in AC/DC conversion unit 42. As control unit 2 stops the power conversion operation in AC/DC conversion unit 42, the drive power supplied to control unit 2, LAN communication unit 34, facsimile communication unit 5 and manipulation unit 62 is switched to the second drive power received from separation unit 32. Furthermore, stopping the power conversion operation in AC/DC conversion unit 42 can reduce a loss in the power conversion operation (representatively, a switching loss provided by a switching device) and also increase the life of the switching device and that of its drive circuit.

Furthermore, when LAN communication unit 34 receives a print instruction from a personal computer PC or the like in the low power consumption mode or facsimile communication unit 5 receives a print instruction from another image formation apparatus MFP or the like in the low power consumption mode, control unit 2 determines whether commercial power is received. If commercial power is received, image formation apparatus MFP returns from the low power consumption mode to the normal mode and the print process is performed in accordance with the received print instruction.

If commercial power is not received, then control unit 2 causes display unit 62b (FIG. 1) to display an indication that the print instruction has been received and an indication urging supplying commercial power. These indications can inform the user that the print instruction has been received and that supplying commercial power should be resumed to perform the print process therefor.

A document or the like that each user has made on his/her personal computer PC is relatively confidential, whereas facsimile data that is transmitted is relatively less confidential. Accordingly if LAN communication unit 34 receives a print instruction in the low power consumption mode, the print instruction may be subjected to the print process once an instruction is received from the user, rather than automatically performing the print process. In other words, when LAN communication unit 34 receives a print instruction in the low power consumption mode, an operation may be provided such that a selection can be made between: first returning image formation apparatus MFP from the low power consumption mode to the normal mode and then performing the print process in accordance with the print instruction; and maintaining the low power consumption mode.

If the latter is selected, then despite the print instruction received from LAN communication unit 34, control unit 2 maintains the low power consumption mode, and also causes display unit 62b (FIG. 1) to display an indication that the print instruction has been received and an indication urging a permission to perform the print process. If in this case a print instruction is received from facsimile control unit 212, and commercial power is received, it is preferable that image formation apparatus MFP return from the low power consumption mode to the normal mode and that the received facsimile data be subjected to the print process.

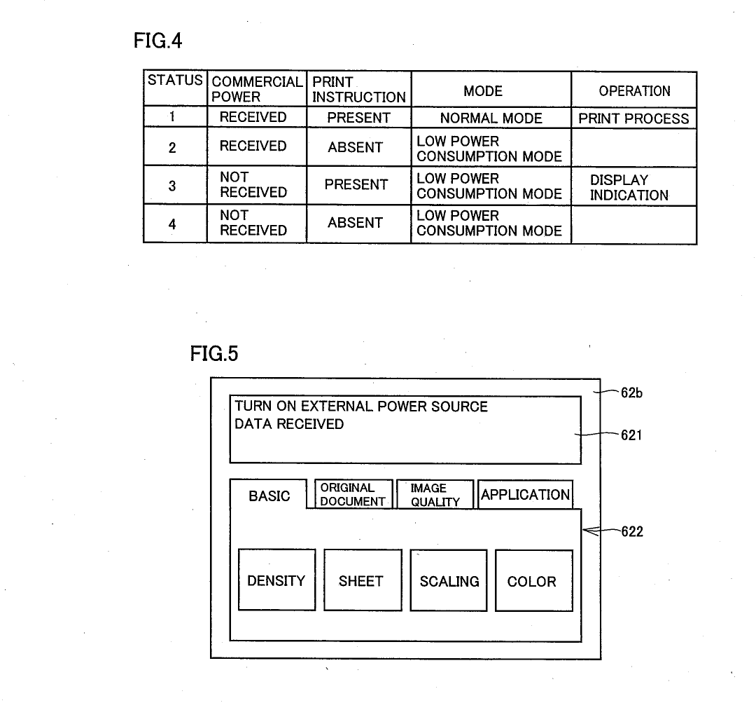

The above described modes in image formation apparatus MFP can be summarized in terms of a relationship between what status commercial power assumes and whether there is a print instruction, as shown in FIG. 4.

With reference to FIG. 4, four statuses 1-4 are provided depending on whether commercial power (the first drive power) is received (or supplied) and whether there is a print instruction.

Status 1 corresponds to where commercial power is received and there is also a print instruction received. In status 1, image formation apparatus MFP is set in the normal mode, and in accordance with the received print instruction, the print process is performed.

Status 2 corresponds to where commercial power is received and no print instruction is received. In status 2, image formation apparatus MFP is set in the low power consumption mode.

Status 3 corresponds to where commercial power is interrupted and there is a print instruction received. In status 3, image formation apparatus MFP is necessitated to be set in the low power consumption mode. In status 3, control unit 2 causes display unit 62b (FIG. 1) to display an indication that the print instruction has been received and an indication urging supplying commercial power.

FIG. 5 shows an exemplary indication displayed by display unit 62b for status 3 shown in FIG. 4.

With reference to FIG. 5, display unit 62b displays a message displaying area 621 and a manipulation inputting area 622. When image formation apparatus MFP is in status 3 (FIG. 4), message displaying area 621 displays a message “TURN ON EXTERNAL POWER SOURCE” as an indication that urges supplying commercial power, and a message “DATA RECEIVED” to indicate that a print instruction has been received. Furthermore, manipulation inputting area 622 displays a manipulation menu for operating the print process in the normal mode.

With reference again to FIG. 4, status 4 corresponds to where commercial power is interrupted and there is no print instruction received. Status 4 also necessitates image formation apparatus MFP to be in the low power consumption mode.

Functional Configuration

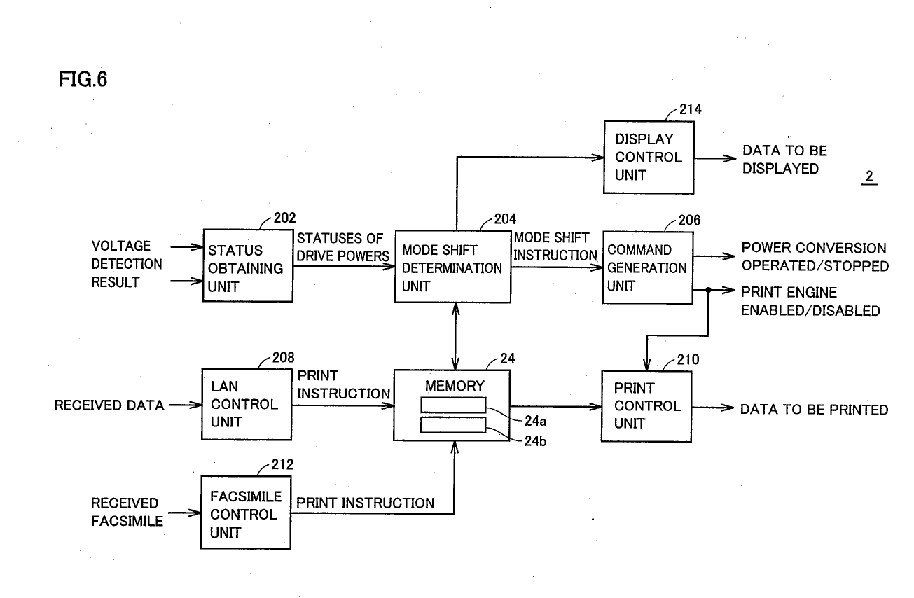

With reference to FIG. 6, in the present embodiment, control unit 2 includes a status obtaining unit 202, a mode shift determination unit 204, a command generation unit 206, a LAN control unit 208, a print control unit 210, a facsimile control unit 212, and a display control unit 214 as its functions. These functions are implemented representatively by CPU 22 (FIG. 2) executing a program previously stored in memory 24 (FIG. 2).

Status obtaining unit 202 determines a status of commercial power from a result as detected by voltage detection unit 47 (FIG. 3). More specifically, if voltage detection unit 47 detects a predetermined voltage value, status obtaining unit 202 determines that commercial power is received, and status obtaining unit 202 outputs the decision as a status of commercial power to mode shift determination unit 204. If voltage detection unit 47 does not detect the predetermined voltage value, status obtaining unit 202 determines that commercial power is interrupted, and status obtaining unit 202 outputs the decision as a status of commercial power to mode shift determination unit 204.

LAN control unit 208 controls transmission and reception of data in LAN communication unit 34 (FIG. 2). In particular, when a print instruction is received through communication line LAN, LAN control unit 208 stores the received print instruction to memory 24.

Facsimile control unit 212 controls transmission and reception of facsimile data in facsimile communication unit 5 (FIG. 2). In particular, when a print instruction is received through telephone line TL, facsimile control unit 212 stores the received print instruction to memory 24.

Memory 24 includes a first storage area 24a storing a print instruction received from LAN control unit 208, and a second storage area 24b storing a print instruction received from facsimile control unit 212 in order to distinguish a relatively more confidential print instruction received from LAN control unit 208 and a relatively less confidential print instruction received from facsimile control unit 212, as has been described previously.

Mode shift determination unit 204 determines from the status of commercial power as determined by status obtaining unit 202 whether image formation apparatus MFP should be shifted from the normal mode to the low power consumption mode or vise versa. More specifically, if commercial power is interrupted in the normal mode, mode shift determination unit 204 determines a shift to the low power consumption mode, and if supplying commercial power is resumed in the low power consumption mode, mode shift determination unit 204 makes a decision in accordance with whether there is a print instruction stored in memory 24 on whether a shift should be made to the normal mode or the low power consumption mode should be maintained. If mode shift determination unit 204 determines that a mode of operation should be changed, mode shift determination unit 204 outputs a mode shift instruction to a command generation unit 206.

Note that mode shift determination unit 204 in shifting from the low power consumption mode to the normal mode determines whether there is any print instruction by referring to first storage area 24a and second storage area 24b or second storage area 24b alone in accordance with the user's setting.

As an exemplary operation in accordance with a user's setting, if supplying commercial power is resumed in the low power consumption mode, and first storage area 24a has any print instruction stored therein and second storage area 24b has no print instruction, mode shift determination unit 204 maintains the low power consumption mode. If supplying commercial power is resumed in the low power consumption mode, and second storage area 24b has any print instruction stored therein, then, whether first storage area 24a may have any print instruction stored therein or not, mode shift determination unit 204 switches the low power consumption mode to the normal mode.

Furthermore, if a print instruction is stored to memory 24, and commercial power has been interrupted, mode shift determination unit 204 outputs a request to display control unit 214 for displaying an indication.

Display control unit 214 receives the request from mode shift determination unit 204, and in response outputs data to display unit 62b (FIG. 1) for displaying that a print instruction has been received and that supplying commercial power is urged.

Command generation unit 206 receives from mode shift determination unit 204 a mode shift instruction indicating that a shift should be made to the low power consumption mode, and in response thereto command generation unit 206 generates a control signal (or command) disabling the print engine from operation and also stopping the power conversion operation in AC/DC conversion unit 42. Furthermore, command generation unit 206 receives from mode shift determination unit 204 a mode shift instruction indicating that a shift should be made to the normal mode, and in response thereto command generation unit 206 generates a control signal (or command) enabling the print engine to operate and also resuming the power conversion operation in AC/DC conversion unit 42.

In response to a control signal received from command generation unit 206 to enable the print engine to operate, print control unit 210 generates data to be printed, as based on a print instruction stored in memory 24, and outputs to the print engine the data to be printed.

By the functional configuration as described above, control unit 2 implements each process according to the present embodiment.

Procedure of Process

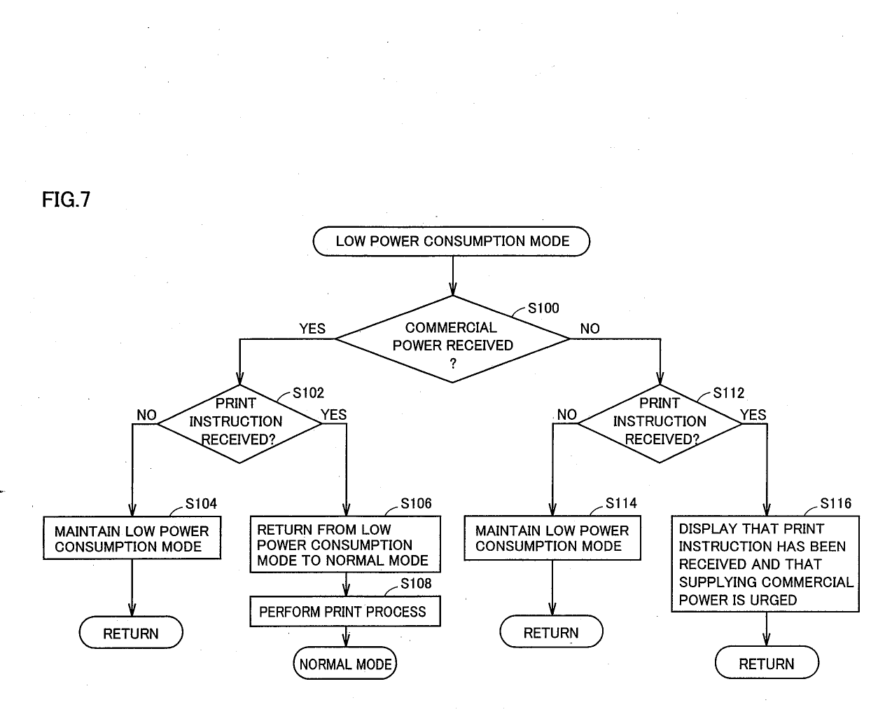

FIG. 7 is a flowchart of a procedure of a process in image formation apparatus MFP in accordance with the first embodiment. The FIG. 7 procedure is implemented by the control unit 2 CPU 22 executing a program stored in memory 24 or the like. Note that the FIG. 7 flowchart is repeatedly performed periodically as predetermined, e.g., every several seconds to every several minutes, when image formation apparatus MFP is set in the low power consumption mode.

With reference to FIG. 7, CPU 22 determines whether commercial power is received (step S100).

If commercial power is received (YES at step S100), CPU 22 determines whether there is any print instruction received (step S102). Note that, as has been described previously, image formation apparatus MFP in accordance with the present embodiment can receive a print instruction from an external device and store it to memory 24 as long as image formation apparatus MFP receives either network power or commercial power.

If there is no print instruction received (NO at step S102), CPU 22 maintains the low power consumption mode (step S104) and returns to the start.

If there is any print instruction received (YES at step S102), CPU 22 returns from the low power consumption mode to the normal mode (step S106), and enables print engine load unit 6 to operate and also resumes the power conversion operation in AC/DC conversion unit 42. Furthermore, CPU 22 outputs the print instruction to the print engine to cause it to perform the print process in accordance with the print instruction (step S108), and performs an operation in the normal mode.

If commercial power is not received (NO at step S100), CPU 22 determines whether there is any print instruction received (step S112). If not (NO at step S112), CPU 22 maintains the low power consumption mode (step S114) and returns to the start.

If there is any print instruction received (YES at step S112), CPU 22 causes display unit 62b (FIG. 1) to display that there is a print instruction received and that supplying commercial power is urged (step S116), and CPU 22 returns to the start.

Exemplary Application

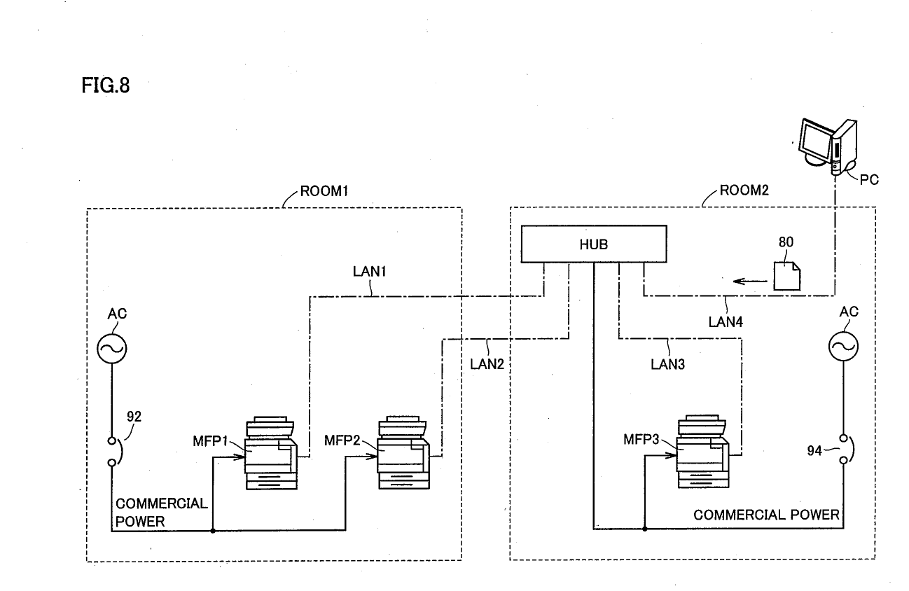

With reference to FIG. 8, for the sake of illustration, an office has a room 1 in which a user does his/her work for his/her business hours and a room 2 in which some service is continuously provided even before and/or after the business hours. Representatively, room 2 is for example a server room accommodating a server device. In room 1, two image formation apparatuses MFPs 1 and 2 are installed. They receive commercial power from power supply system AC via a breaker 92. Furthermore, in room 2, one image formation apparatus MFP3 and hub device HUB are installed. They receive commercial power from power supply system AC via a breaker 94.

Image formation apparatuses MFPs 1-3 are connected to hub device HUB via communication lines LANs 1-3, respectively. As has been described previously, hub device HUB is equipped with a power supplying function, and supplies power to image formation apparatuses MFPs 1-3 via communication lines LANs 1-3, respectively.

Furthermore, personal computer PC is connected to hub device HUB via a communication line LAN4. Personal computer PC transmits a print instruction 80 for example to image formation apparatus MFP 1. Image formation apparatus MFP1 receives print instruction 80 and performs the print process in accordance with print instruction 80.

Herein, to reduce power consumption in room 1, a system is discussed that stops supplying power to room 1 after all users have left room 1. More specifically, once all users have left room 1, breaker 92 is opened. In such a case, a conventional image formation apparatus would completely stop operation, and personal computer PC cannot communicate data with the conventional image formation apparatus.

In the present embodiment, in contrast, if supplying commercial power is interrupted, image formation apparatus MFP1 can employ the network power supplied from hub device HUB to maintain a data communication function. Image formation apparatus MFP 1 can thus receive print instruction 80 from personal computer PC. Image formation apparatus MFP 1 stores the received print instruction 80 to memory, and when a user enters room 1 and supplying commercial power is resumed, image formation apparatus MFP 1 performs the print process in accordance with the stored print instruction 80, or when print instruction 80 is received while supplying commercial power is interrupted, image formation apparatus MFP1 displays to the user an indication that print instruction 80 has been received and that supplying commercial power is urged.

Thus the present embodiment provides image formation apparatus MFP that can establish both reducing power consumed in the entirety of a particular room and being constantly capable of receiving data transmitted from an external device at any time.

In accordance with the present embodiment image formation apparatus MFP can receive a print instruction from an external device and store it if image formation apparatus MFP receives either commercial power from a power supply system or the like or network power supplied through a communication line. Furthermore when supplying commercial power is resumed in the low power consumption mode, then image formation apparatus MFP returns to the normal mode and then performs the print process if a print instruction has been received. Thus if there is no print instruction received and it is thus unnecessary to perform the print process, the low power consumption mode can be maintained and unnecessary power consumption can thus be reduced or prevented.

Furthermore in accordance with the present embodiment when image formation apparatus MFP has received any print instruction from an external device and commercial power is not received, a display unit displays that the print instruction has been received and that supplying commercial power is urged. This can help a user to recognize that supplying image formation apparatus MFP with commercial power should be resumed. This allows the print process to be timely performed and image formation apparatus MFP to be efficiently operated.

### Second Embodiment

The first embodiment has been described with switch unit 46 held at the closed position. However, some users may switch switch unit 46 to the open position to shut down image formation apparatus MFP before supplying commercial power to image formation apparatus MFP is interrupted. In that case, if supplying commercial power is resumed, the print process is not performed immediately. Accordingly in the second embodiment assistance is provided for the user in accordance with the status of switch unit 46.

The second embodiment provides image formation apparatus MFP having an external appearance and a functional configuration similar to those shown in FIGS. 1 and 2, respectively. Accordingly they will be not described repeatedly in detail.

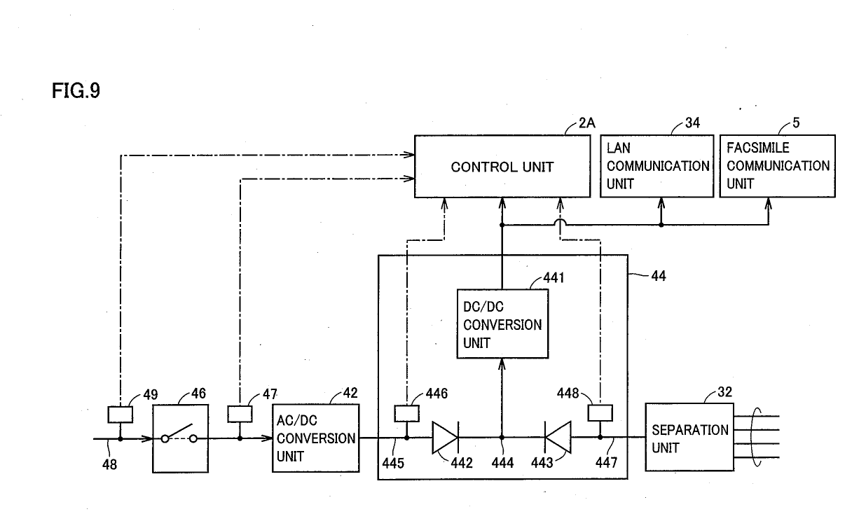

With reference to FIG. 9, the present embodiment provides a configuration of a main portion involved in supplying power that corresponds to the FIG. 3 configuration that has control unit 2 replaced with a control unit 2A and is further provided with a voltage detection unit 49 for detecting a value in voltage appearing on commercial power supplying line 48. Voltage detection unit 49 can detect whether image formation apparatus MFP is supplied with commercial power regardless of whether switch unit 46 is turned on or off (or assumes the open position or the closed position).

The remainder is similar to that shown in FIG. 3, and accordingly, will not be described repeatedly in detail.

Mode of Operation

Hereinafter it is assumed that image formation apparatus MFP is continuously supplied with network power through communication line LAN and that switch unit 46 can be switched to any of the closed position and the open position.

In accordance with the present embodiment control unit 2A changes a mode of operation of image formation apparatus MFP in accordance with whether commercial power is received, similarly as described in the first embodiment. More specifically, if supplying commercial power is resumed in the low power consumption mode, control unit 2A determines whether there is any print instruction in memory 24, and if so, a return is made from the low power consumption mode to the normal mode.

Note that if commercial power is received and switch unit 46 assumes the open position, AC/DC conversion unit 42 (FIG. 2) cannot supply print engine load unit 6 (FIG. 2) with drive power. Accordingly, control unit 2A determines whether switch unit 46 is turned on/off (or assumes the open position or the closed position), and performs a process in accordance with the decision. Note that control unit 2A representatively compares a result of detecting by voltage detection unit 49 and that of detecting by voltage detection unit 47 to determine whether switch unit 46 is turned on/off. More specifically, if voltage detection unit 49 detects a predetermined voltage and voltage detection unit 47 does not detect voltage, a decision is made that switch unit 46 assumes the open position. If voltage detection unit 49 detects the predetermined voltage and voltage detection unit 47 also detects a predetermined voltage, a decision is made that switch unit 46 assumes the closed position. It should be noted that if voltage detection unit 49 does not detect voltage, whether switch unit 46 is turned on/off cannot be determined.

If a print instruction is received in the low power consumption mode, and switch unit 46 assumes the open position and commercial power is not received, then control unit 2A causes display unit 62b (FIG. 1) to display that a print instruction has been received and that supplying commercial power and switching switch unit 46 to the closed position are urged. The indication thus displayed can inform the user that supplying commercial power should be resumed and switch unit 46 should be turned on to subject the received print instruction to the print process.

Furthermore, if a print instruction is received in the low power consumption mode, and switch unit 46 assumes the open position and commercial power is received, then control unit 2A causes display unit 62b (FIG. 1) to display that a print instruction has been received and that switching switch unit 46 to the closed position is urged. The indication thus displayed can inform the user that switch unit 46 should be turned on to subject the received print instruction to the print process.

Furthermore if the user turns on switch unit 46 (or changes it from the open position to the closed position) in the low power consumption mode, then regardless of whether there is a print instruction received, control unit 2A returns from the low power consumption mode to the normal mode. This is because a user operates switch unit 46 often when the user needs to use image formation apparatus MFP, and accordingly it is preferable to reflect the user's such demand and thus return image formation apparatus MFP to the normal mode. Note that preferably, image formation apparatus MFP thus returned to the normal mode maintains an operation in the normal mode only for any set time, and once the set time has elapsed, image formation apparatus MFP is shifted to the low power consumption mode.

Furthermore, similarly as has been described in the first embodiment, if LAN communication unit 34 receives a print instruction in the low power consumption mode, then the print instruction may be subjected to the print process once an instruction is received from a user, rather than automatically performing the print process. In other words, when LAN communication unit 34 receives a print instruction in the low power consumption mode, an operation may be provided such that a selection can be made between: first returning image formation apparatus MFP from the low power consumption mode to the normal mode and then performing the print process in accordance with the print instruction; and maintaining the low power consumption mode.

More specifically, if the latter is selected, and supplying commercial power is resumed in the low power consumption mode and a print instruction has been received only from LAN communication unit 34, control unit 2A maintains the low power consumption mode. At the time, control unit 2A causes display unit 62b (FIG. 1) to display that the print instruction has been received and that permission for the print process is urged. In contrast, if supplying commercial power is resumed in the low power consumption mode and there has been a print instruction received from facsimile control unit 212, then control unit 2A switches the low power consumption mode to the normal mode regardless of whether there is a print instruction received from LAN communication unit 34.

The above described modes in image formation apparatus MFP can be summarized in terms of a relationship between what status commercial power assumes, whether switch unit 46 is turned on/off, and whether there is a print instruction, as shown in FIG. 10.

With reference to FIG. 10, six statuses 1 to 6 are provided depending on whether commercial power (or the first drive power) is input (or received), whether switch unit 46 is turned on/off, and whether there is a print instruction.

Status 1 corresponds to where commercial power is received, switch unit 46 assumes the closed position, and any print instruction has been received. In status 1, image formation apparatus MFP is set in the normal mode, and in accordance with the received print instruction, the print process is performed.

Status 2 corresponds to where commercial power is received, switch unit 46 assumes the closed position, and no print instruction has been received. Status 2 also sets image formation apparatus MFP in the low power consumption mode. If a user turns on switch unit 46 (or changes it from the open position to the closed position), image formation apparatus MFP returns from the low power consumption mode to the normal mode.

Status 3 corresponds to where commercial power is received, switch unit 46 assumes the open position, and any print instruction has been received. In status 3, print engine load unit 6 (FIG. 2) is not supplied with drive power, and the print process cannot be performed. Accordingly in status 3 control unit 2A causes display unit 62b (FIG. 1) to display that a print instruction has been received and that switching switch unit 46 to the closed position is urged.

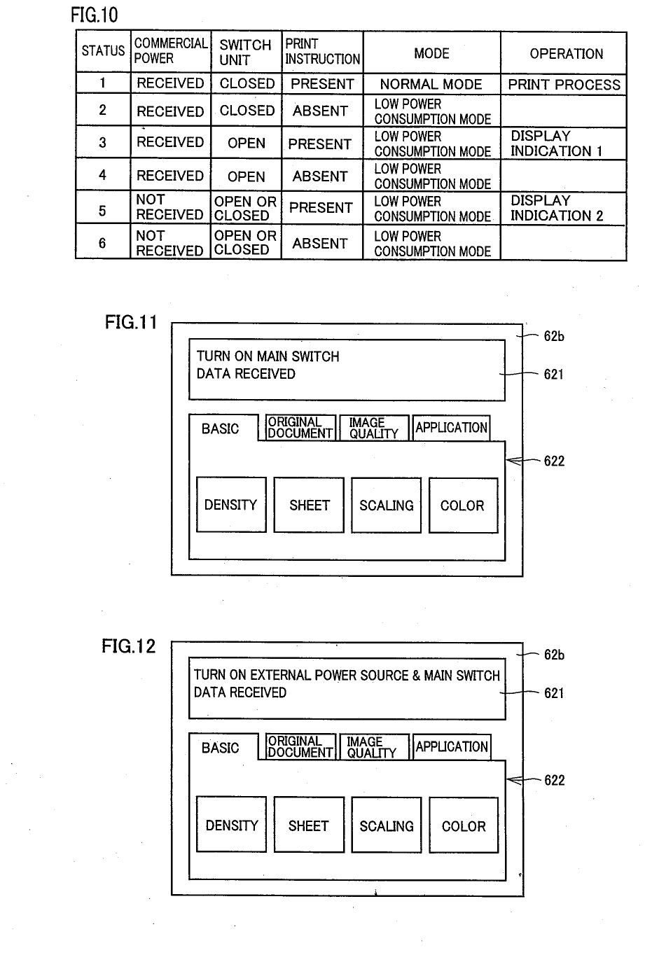

FIG. 11 shows an example of an indication displayed by display unit 62b for status 3 shown in FIG. 10.

With reference to FIG. 11, display unit 62b displays message displaying area 621 and manipulation inputting area 622. In status 3 (FIG. 10), message displaying area 621 displays a message “TURN ON THE MAIN SWITCH” to indicate that switching switch unit 46 to the closed position is urged, and a message “DATA RECEIVED” to indicate that a print instruction has been received. Manipulation inputting area 622 displays a manipulation menu for operating the print process in the normal mode.

With reference again to FIG. 10, status 4 corresponds to where commercial power is received, switch unit 46 assumes the open position, and no print instruction has been received. In status 4, image formation apparatus MFP is set in the low power consumption mode.

Status 5 corresponds to where supplying commercial power is interrupted and any print instruction has been received. Whether switch unit 46 is turned on/off (or assumes the open position or the closed position) does not matter. In status 5, print engine load unit 6 (FIG. 2) is not supplied with drive power, and the print process cannot be performed. Accordingly, in status 5, control unit 2A causes display unit 62b (FIG. 1) to display that a print instruction has been received and that supplying commercial power and switching switch unit 46 to the closed position are urged.

FIG. 12 shows an example of an indication displayed by display unit 62b for status 5 shown in FIG. 10.

With reference to FIG. 12, display unit 62b displays message displaying area 621 and manipulation inputting area 622. In status 5 (FIG. 10), message displaying area 621 displays a message “TURN ON EXTERNAL POWER SOURCE AND MAIN SWITCH” to urge supplying commercial power and switching switch unit 46 to the closed position and a message “DATA RECEIVED” to indicate that any print instruction has been received. Furthermore manipulation inputting area 622 displays a manipulation menu for operating the print process in the normal mode.

With reference again to FIG. 10, status 6 corresponds to where supplying commercial power is interrupted and no print instruction has been received. In status 6, image formation apparatus MFP is set in the low power consumption mode, whether a main switch 46 may be turned on or off.

Functional Configuration

In the second embodiment control unit 2A has a functional configuration similar to that of control unit 2 in accordance with the first embodiment as shown in FIG. 6. Accordingly, it will not be described repeatedly in detail.

Procedure of Process

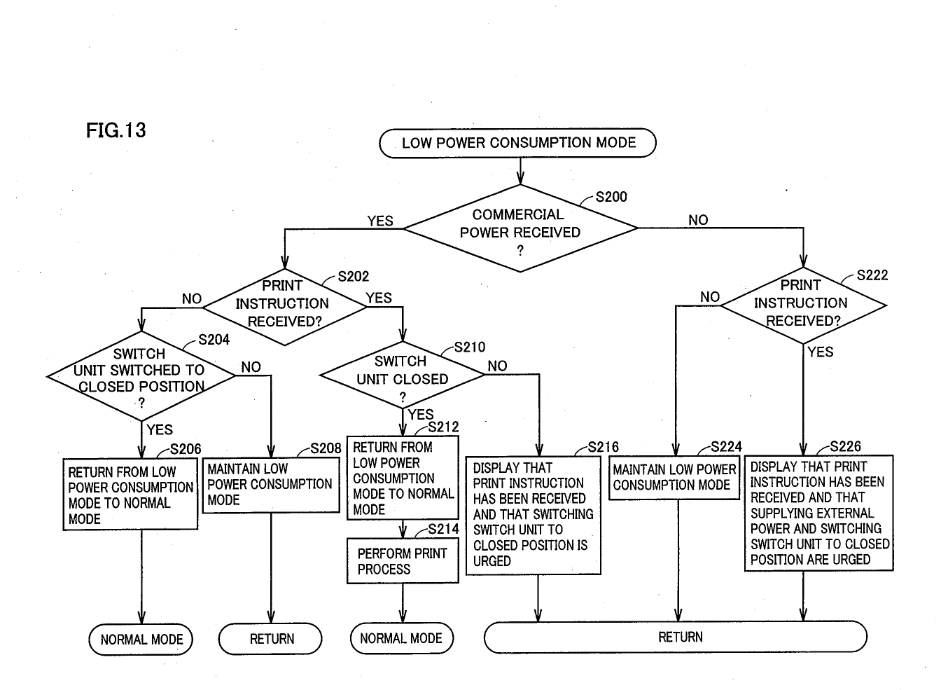

FIG. 13 is a flow chart of a procedure of a process performed by image formation apparatus MFP in accordance with the second embodiment. The FIG. 13 procedure is implemented by the control unit 2 CPU 22 executing a program stored in memory 24 or the like. Note that the FIG. 13 flowchart is repeatedly performed periodically as predetermined, e.g., every several seconds to every several minutes, when image formation apparatus MFP is set in the low power consumption mode.

With reference to FIG. 13, CPU 22 determines whether commercial power is received (step S200).

If so (YES at step S200), CPU 22 determines whether there is any print instruction received (step S202). Note that, as has been described previously, image formation apparatus MFP in accordance with the present embodiment can receive a print instruction from an external device and store it to memory 24 as long as image formation apparatus MFP receives either network power or commercial power.

If there is no print instruction received (NO at step S202), CPU 22 determines whether switch unit 46 has been switched from the open position to the closed position (step S204). More specifically, CPU 22 determines that switch unit 46 has been switched from the open position to the closed position if switch unit 46 assumes the open position in the previous processing cycle and the closed position in the current processing cycle.

If switch unit 46 is switched from the open position to the closed position (YES at step S204), CPU 22 returns from the low power consumption mode to the normal mode (step S206), enables print engine load unit 6 to operate and resumes the power conversion operation in AC/DC conversion unit 42, and performs an operation in the normal mode.

If switch unit 46 is not switched from the open position to the closed position (NO at step S204) CPU 22 maintains the low power consumption mode (step S208) and returns to the start.

If there is any print instruction received (YES at step S202), CPU 22 determines whether switch unit 46 assumes the closed position (step S210).

If so (YES at step S210), CPU 22 returns from the low power consumption mode to the normal mode (step S212), enables print engine load unit 6 to operate and resumes the power conversion operation in AC/DC conversion unit 42. Furthermore, CPU 22 outputs the print instruction to the print engine and causes it to perform the print process in accordance with the print instruction (step S214), and performs an operation in the normal mode.

If switch unit 46 assumes the open position (NO at step S210), CPU 22 causes display unit 62b (FIG. 1) to display that a print instruction has been received and that switching switch unit 46 to the closed position is urged (step S216), and CPU 22 returns to the start.

If commercial power is not received (NO at step S200), CPU 22 determines whether there is any print instruction received (step S222). If not (NO at step S222), CPU 22 maintains the low power consumption mode (step S224) and returns to the start.

If there is any print instruction received (YES at step S222), CPU 22 causes display unit 62b (FIG. 1) to display that any print instruction has been received and that supplying commercial power and switching switch unit 46 to the closed position are urged (step S226), and CPU 22 returns to the start.

The present invention in the second embodiment can provide an effect of the first embodiment and in addition thereto a more user friendly image formation apparatus MFP. More specifically, If a user has switched a switch unit that serves as a main switch to the open position and image formation apparatus MFP thus cannot return from the low power consumption mode to the normal mode and perform the print process, an operation that the user should do can be indicated on a display of image formation apparatus MFP. This can help a user who is not used to operating image formation apparatus MFP to operate image formation apparatus MFP.

Second Embodiment In First Exemplary Variation

In the second embodiment a result of detecting by voltage detection unit 49 and that of detecting by voltage detection unit 47 are compared by way of example to determine whether switch unit 46 is turned on/off. Alternatively, whether switch unit 46 is turned on/off may be obtained directly.

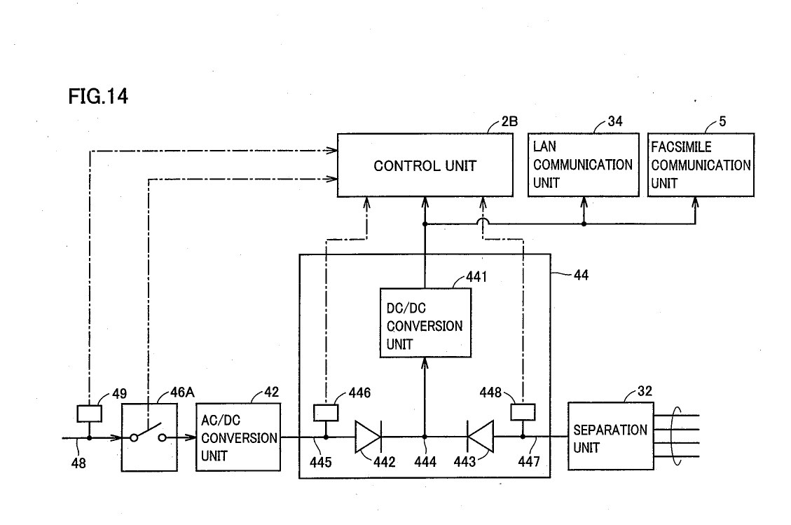

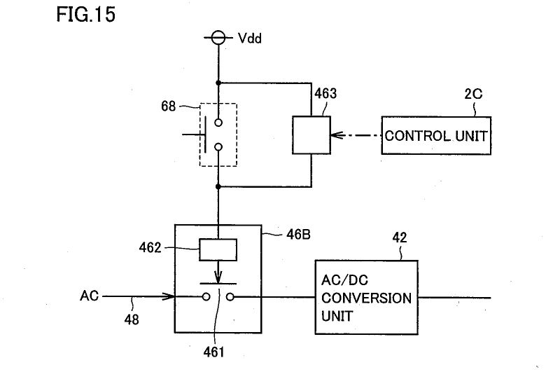

With reference to FIG. 14, the second embodiment in a first exemplary variation provides a main portion involved in supplying power that has a configuration corresponding to that of the main portion involved in supplying power in accordance with the second embodiment as shown in FIG. 9, that has control unit 2A replaced with a control unit 2B and switch unit 46 replaced with a switch unit 46A and has voltage detection unit 47 removed therefrom. Switch unit 46A outputs a signal in accordance with a position of a movable contact for opening and closing a power path. Control unit 2B receives the signal from switch unit 46A and determines therefrom whether switch unit 46A is turned on or off (or assumes an open position or a closed position).

The remainder is similar to that described in the second embodiment, and accordingly, will not be described repeatedly in detail.

Second Embodiment In Second Exemplary Variation

In the second embodiment as described above, if a print instruction is received in the low power consumption mode, and commercial power is received and switch unit 46 assumes the open position, then display unit 62b (FIG. 1) displays that switching switch unit 46 to the closed position is urged. In such a status (status 3 shown in FIG. 10), the switch unit may be automatically turned on. Hereinafter will be illustrated a configuration allowing the switch unit to be automatically turned on.

With reference to FIG. 15, the second embodiment in a second exemplary variation provides image formation apparatus MFP including a switch unit 46B inserted on a power path extending between power supply system AC and AC/DC conversion unit 42. Switch unit 46B includes a movable contact 461 for electrically opening and closing a power path extending between power supply system AC and AC/DC conversion unit 42, and a drive coil 462 for driving movable contact 461. Drive coil 462 is driven as a power supply potential Vdd is applied via a manual switch 68 or a relay 463, and the power path is set in an electrically closed position. If power supply potential Vdd is not applied to drive coil 462, a return spring (not shown) causes movable contact 461 to bring the power path to an electrically open position.

Manual switch 68 is selectively turned on/off by a user operating it. Relay 463 is driven to a closed position by an instruction issued from control unit 2C for driving. More specifically, image formation apparatus MFP can be supplied with commercial power either via manual switch 68 operated by a user or in accordance with the instruction issued from control unit 2C for driving.

If it is necessary to switch switch unit 46B to the closed position in order to perform the print process (status 3 in FIG. 10), control unit 2C outputs the instruction for driving, and without the user operating switch unit 46B, automatically switches switch unit 46B to the closed position.

Control unit 2C operates such that the FIG. 13 step S216, i.e., the step of displaying that a print instruction has been received and that switching switch unit 46 to the closed position is urged is replaced with providing an instruction to relay 463 for driving, and changing switch unit 46B to the closed position.

In the second embodiment in the second exemplary variation if it is necessary to perform the print process regardless of whether switch unit 46B is turned on or off, image formation apparatus MFP can automatically return to the normal mode. This allows a user who is not used to operating image formation apparatus MFP to also obtain a result of printing, and simultaneously allows image formation apparatus MFP to perform the print process more efficiently.

### Other Embodiment

In the above embodiments the present image formation apparatus is described as an MFP having a plurality of functions such as a copying function, a printing function, a facsimile function and a scanner function mounted therein by way of example. However, the present image formation apparatus is not limited thereto. For example it may be a digital copier, a printer, a facsimile device or the like having a network communication function.

Furthermore, while print engine load unit 6 is illustrated representatively as sensor unit 64 and drive unit 66, it is not necessarily required to include them all. For example, sensor unit 64 may be excluded from print engine load unit 6.

Furthermore, while the above embodiments have been described such that display unit 62b configured of LCD or the like displays messages (FIG. 5, FIG. 11, FIG. 12), the messages may be replaced with a plurality of LEDs or similar lamps previously associated with the messages and turned on to correspond thereto. Alternatively, the messages may be output audibly.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image formation apparatus connected through a data communication line to a power supplying device capable of supplying power through said data communication line, comprising:
a power load unit for performing a process involved in forming an image;
a power conversion unit receiving external power from an external power source and converting said external power to first drive power;
a separation unit connected to said data communication line, and separating a communication signal and supplied power flowing through said data communication line, and outputting as second drive power said supplied power separated;
a data communication unit for communicating data with an external device;
a control unit changing a mode of operation at least between a first mode allowing said process in said power load unit to be performed on said external power and a second mode dispensing with said external power;
a power supply unit continuously supplying at least said control unit and said data communication unit with one of said first drive power and said second drive power; and
a first detection unit detecting said external power, wherein
when supplying said external power is started in said second mode:
said control unit changes said mode of operation from said second mode to said first mode if said data communication unit has received a print instruction; and
said control unit maintains said second mode if said data communication unit has not received said print instruction.

2. The image formation apparatus according to claim 1, further comprising a display unit capable of displaying information, wherein when said data communication unit receives said print instruction in said second mode:
said control unit changes said mode of operation from said second mode to said first mode if said external power is received; and
said control unit causes said display unit to display an indication urging supplying said external power if said external power is not received.

3. The image formation apparatus according to claim 1, wherein:
said data communication unit includes a first communication unit communicating data by said communication signal and a second communication unit communicating data through a telephone line;
said control unit includes a storage unit storing said print instruction received by said first communication unit and said print instruction received by said second communication unit; and
when supplying said external power is started in said second mode, said control unit maintains said second mode if said storage unit has stored therein only said print instruction received by said first communication unit.

4. The image formation apparatus according to claim 1, wherein while said second mode is set, said control unit prevents a power conversion operation in said power conversion unit.

5. An image formation apparatus connected through a data communication line to a power supplying device capable of supplying power through said data communication line, comprising:
a power load unit for performing a process involved in forming an image;
a power conversion unit receiving external power from an external power source and converting said external power to first drive power;
a switch unit disposed on a power path extending from said external power source to said power conversion unit for opening and closing said power path;
a separation unit connected to said data communication line, and separating a communication signal and supplied power flowing through said data communication line, and outputting as second drive power said supplied power separated;
a data communication unit for communicating data with an external device;
a control unit changing a mode of operation at least between a first mode allowing said process in said power load unit to be performed on said external power and a second mode dispensing with said external power;
a power supply unit continuously supplying at least said control unit and said data communication unit with one of said first drive power and said second drive power;
a first detection unit detecting said external power; and
a second detection unit detecting a status of said switch unit, wherein
when supplying said external power is started in said second mode:
said control unit changes said mode of operation from said second mode to said first mode if said switch unit assumes a closed position and said data communication unit has received a print instruction; and
said control unit maintains said second mode if said data communication unit has not received said print instruction.

6. The image formation apparatus according to claim 5, further comprising a display unit capable of displaying information, wherein when supplying said external power is started in said second mode, said control unit causes said display unit to display an indication urging changing said switch unit to said closed position if said switch unit assumes an open position and said data communication unit has received said print instruction.

7. The image formation apparatus according to claim 5, further comprising a display unit capable of displaying information, wherein when said data communication unit receives said print instruction in said second mode:
said control unit causes said display unit to display an indication urging supplying said external power and an indication urging changing said switch unit to said closed position if said switch unit assumes an open position and said external power is not received; and
said control unit causes said display unit to display said indication urging changing said switch unit to said closed position if said switch unit assumes said open position and said external power is received.

8. The image formation apparatus according to claim 5, further comprising a display unit capable of displaying information, wherein: when said data communication unit receives said print instruction in said second mode:
said control unit causes said display unit to display an indication urging supplying said external power and an indication urging changing said switch unit to said closed position if said switch unit assumes an open position and said external power is not received; and
said control unit closes said switch unit if said switch unit assumes said open position and said external power is received.

9. The image formation apparatus according to claim 5, wherein when said switch unit is changed from an open position to said closed position in said second mode, said control unit changes said mode of operation from said second mode to said first mode.

10. The image formation apparatus according to claim 5, wherein:
said data communication unit includes a first communication unit communicating data by said communication signal and a second communication unit communicating data through a telephone line;
said control unit includes a storage unit storing said print instruction received by said first communication unit and said print instruction received by said second communication unit; and
when said storage unit has stored therein only said print instruction received by said first communication unit, said control unit maintains said second mode if supplying said external power is started in said second mode.

11. The image formation apparatus according to claim 5, wherein while said second mode is set, said control unit prevents a power conversion operation in said power conversion unit.

12. A method of controlling an image formation apparatus connected through a data communication line to a power supplying device capable of supplying power through said data communication line, said image formation apparatus including:
a control unit;
a power load unit for performing a process involved in forming an image;
a power conversion unit receiving external power from an external power source and converting said external power to first drive power;
a separation unit connected to said data communication line, and separating a communication signal and supplied power flowing through said data communication line, and outputting as second drive power said supplied power separated;
a data communication unit for communicating data with an external device; and
a power supply unit continuously supplying at least said control unit and said data communication unit with one of said first drive power and said second drive power, said image formation apparatus operating in either one of at least a first mode allowing said process in said power load unit to be performed on said external power and a second mode dispensing with said external power, the method comprising the steps of:
determining whether supplying said external power is started in said second mode;
determining whether said data communication unit has received a print instruction;
changing a mode of operation from said second mode to said first mode if supplying said external power is started in said second mode and said data communication unit has received said print instruction; and
maintaining said second mode if supplying said external power is started in said second mode and said data communication unit has not received said print instruction.

13. The method according to claim 12, further comprising the steps of:
changing said mode of operation from said second mode to said first mode if said data communication unit has received said print instruction in said second mode and said external power is received; and
displaying an indication urging supplying said external power if said data communication unit has received said print instruction in said second mode and said external power is not received.

14. The method according to claim 12, said data communication unit including a first communication unit communicating data by said communication signal and a second communication unit communicating data through a telephone line, the method further comprising the steps of:
storing said print instruction received by said first communication unit and/or said print instruction received by said second communication unit; and
maintaining said second mode if only said print instruction received by said first communication unit has been stored and supplying said external power is started in said second mode.

15. The method according to claim 12, further comprising the step of preventing a power conversion operation in said power conversion unit while said second mode is set.

16. A method of controlling an image formation apparatus connected through a data communication line to a power supplying device capable of supplying power through said data communication line, said image formation apparatus including:
a control unit;
a power load unit for performing a process involved in forming an image;
a power conversion unit receiving external power from an external power source and converting said external power to first drive power;
a switch unit disposed on a power path extending from said external power source to said power conversion unit for opening and closing said power path;
a separation unit connected to said data communication line, and separating a communication signal and supplied power flowing through said data communication line, and outputting as second drive power said supplied power separated;
a data communication unit for communicating data with an external device; and
a power supply unit continuously supplying at least said control unit and said data communication unit with one of said first drive power and said second drive power, said image formation apparatus operating in either one of at least a first mode allowing said process in said power load unit to be performed on said external power and a second mode dispensing with said external power, the method comprising the steps of:
determining whether supplying said external power is started in said second mode;
determining whether said data communication unit has received a print instruction;
determining a status of said switch unit;
changing a mode of operation from said second mode to said first mode if supplying said external power is started in said second mode, said switch unit assumes a closed position, and said data communication unit has received said print instruction; and
maintaining said second mode if supplying said external power is started in said second mode and said data communication unit has not received said print instruction.

17. The method according to claim 16, further comprising the step of displaying an indication urging changing said switch unit to said closed position if supplying said external power is started in said second mode, said switch unit assumes an open position, and said data communication unit has received said print instruction.

18. The method according to claim 16, further comprising the steps of:
displaying an indication urging supplying said external power and an indication urging changing said switch unit to said closed position if said data communication unit has received said print instruction in said second mode, said switch unit assumes an open position, and said external power is not received; and
displaying said indication urging changing said switch unit to said closed position if said data communication unit has received said print instruction in said second mode, said switch unit assumes said open position, and said external power is received.

19. The method according to claim 16, further comprising the steps of:
displaying an indication urging supplying said external power and an indication urging changing said switch unit to said closed position if said data communication unit has received said print instruction in said second mode, said switch unit assumes an open position, and said external power is not received; and
closing said switch unit if said data communication unit has received said print instruction in said second mode, said switch unit assumes said open position, and said external power is received.

20. The method according to claim 16, further comprising the step of changing said mode of operation from said second mode to said first mode if said switch unit is changed from an open position to said closed position in said second mode.

21. The method according to claim 16, said data communication unit including a first communication unit communicating data by said communication signal and a second communication unit communicating data through a telephone line, the method further comprising the steps of:
storing said print instruction received by said first communication unit and/or said print instruction received by said second communication unit; and
maintaining said second mode if only said print instruction received by said first communication unit is stored and supplying said external power is started in said second mode.

22. The method according to claim 16, further comprising the step of preventing a power conversion operation in said power conversion unit while said second mode is set.
